(19) United States
(12) Patent Application Publication
(10) Pub. No.: US 2010/0332567 A1
(43) Pub. Date: Dec. 30, 2010

(54) Media Playlist Generation

(76) Inventor: Ramin Samadani, Palo Alto, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/492,568

(22) Filed: Jun. 26, 2009

(51) Int. Cl. G06F 17/00

(52) U.S. Cl. 707/912; 707/955; 707/957

(57) ABSTRACT

Systems and computer readable mediums storing computer executable programs for generating a media playlist are disclosed. A first media item is selected from a plurality of media items for playback. A first determination is made regarding the number of times each of the plurality of media items was accessed for playback following an access for playback of the first media item. Each of the plurality of media items is weighted such that the probability of stochastically selecting each of the plurality of media items as a second media item for playback following a playback of the first media item is based on the first determination. The second media item is stochastically selected from the weighted plurality of media items for playback following the first media item.

### BACKGROUND OF THE INVENTION

Many individuals often have relatively large media items collections. Examples of media items include but are not limited to songs, photographs and video. Many media playback device provide a user with an option of generating media playlists including a sequence of media items for playback. For example, a media playlist may include a sequence of songs or a sequence of photographs. In this invention playlist refers to the sequence of media, and not necessarily a complete list of media, since the playlist can be generated on the fly, optionally stochastically, one media item at a time.

In some prior art devices, generated media playlists consist of media items that are stochastically selected from the user media collection. Such media playlists may not reflect current user taste. For example, a stochastically generated song playlist may not include the user's favorite songs. Some prior art devices track the number of times media items in a media collection are selected for playback recently and generate media playlists that include the media items that are most frequently accessed by the user.

In many prior art devices, a user is provided an option of manually tagging media items to reflect user interest in such media items. Such prior art devices often generate media playlists based on the user preferences provided in the user provided tags. Manual tagging can often be a time consuming process and may require affirmative effort on the part of the user. In many cases user taste and preferences may change over time. In order for a prior art device to generate media playlists that reflect current user preferences, the user may have to update the tags associated with the media items in the user media collection.

### BRIEF DESCRIPTION OF THE DRAWINGS

FIG. 1 is a block diagram representation of an example of a media playback device that may be used to implement an embodiment of generating a media playlist;

FIG. 2 is a block diagram representation of one embodiment of a playlist generation module;

FIG. 3 is a flowchart representation of one embodiment of a method of generating an event state vector;

FIG. 4 is a flowchart representation of one embodiment of a method of identifying media items accessed for playback during a user specified period of time;

FIG. 5 is a flowchart representation of one embodiment of a method 500 of selecting the first media item in a media playlist;

FIG. 6 is a flowchart representation of one embodiment of a method of generating a next media item in a media playlist; and

FIG. 7 is a flowchart representation of one embodiment of a method of generating a media playlist.

### DETAILED DESCRIPTION OF THE DRAWINGS

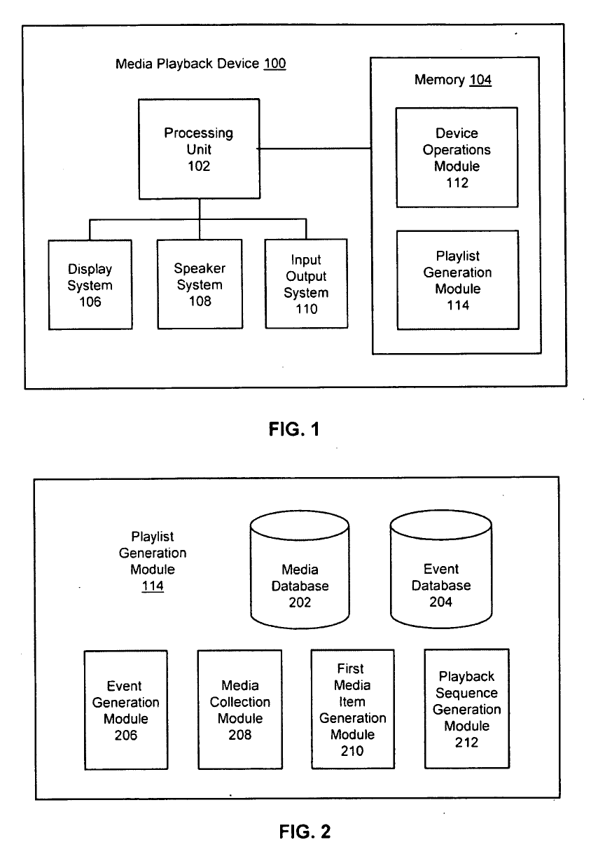

Referring to FIG. 1, a block diagram representation of an example of a media playback device 100 that may be used to implement an embodiment of generating a media playlist is shown. The media playback device 100 generally enables a user to store one or more media items and selectively access one or more of those media items for playback. Examples of the types of media items include, but are not limited, to audio media items, image media items and video media items. In one embodiment, the media playback player 100 generates media playlists or sequences of media items for playback that reflect the preferences of a user during a selected time period. Examples of media playlists include, but are not limited to, a sequence of songs and a sequence of photographs that were accessed by a user for playback during the selected period of time. The media items are ordered in the media playlist to reflect the preferences of the user during the selected period of time.

The media playback device 100 generally includes a processing unit 102 communicatively coupled to a memory 104, a display system 106, a speaker system 108 and one or more input and/or output systems 110. A device operations module 112 and playlist generation module 114 are stored in the memory 104. The device operations module 112 handles the media playback related operations of the media playback device 100. The playlist generation module 114 generally manages the generation of media playlists that reflect the time varying interests or preferences of a user. Other modules that facilitate the operation of the media playback device 100 may also be stored in the memory 104.

The processing unit 102 generally includes a processor or controller. In one embodiment, the display screen 106 is used to display selected image media items, such as for example photographs. In one embodiment, the display screen 106 is used to display selected video media items. In one embodiment the speaker system 108 is used to enable playback of selected audio media items. In one embodiment, the media playback device 100 includes a display screen 106. In one embodiment, the media playback device 100 includes a speaker system 108. In one embodiment, the media playback device 100 includes both a display screen 106 and a speaker system 106. In one embodiment, the memory 104 includes one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, and flash memory devices. The processing unit 102 generally retrieves and executes machine readable instructions or software programs that are stored in the memory 104.

While the use of a media playback device 100 has been described in connection with the generation of media playlists, it should be noted that other type of devices, such as for example including, but not limited to, personal computers and personal digital assistants may be used to generate media playlists. In one embodiment, the media playlist is generated in one device and the generated media playlist is provided to a media playback device 100. The media playback device 100 plays back the ordered sequence of media items defined in the media playlist.

Referring to FIG. 2, a block diagram representation of one embodiment of a playlist generation module 114 is shown. The playlist generation module 114 generally manages the generation of media playlists that reflect time varying interests or preferences of a user. In one embodiment, a user specifies a time period. The playlist generation module 114 responsively retrieves the media items that the user accessed for playback during the specified time period and generates an ordered sequence of the retrieved media items in the form of a media playlist for playback. The order of the sequence of the retrieved media items reflects the relative popularity of those media items with the user. This enables a user, for example, to specify that the user would like to listen to a sequence of songs that he accessed for playback in the 1990's. The playlist generation module 114 responsively retrieves those media items that the user accessed for playback in the 1990's and generates a media playlist of an ordered sequence of the retrieved media items where the ordered sequence reflects the general relative popularity of the media items in accordance with user interests or preferences in the 1990's.

In one embodiment, responsive to user commands, the playlist generation module 114 generates multiple different media playlists for the specified period of time. These playlists may be generated on the fly in real-time and correspond to stochastic sequences of media. Each of the different media playlists includes a different ordered sequence of the media items associated with the user interests or preferences during the specified period. Each of the different ordered sequences generally reflect the relative popularity of the media items with the user during the specified period of time. This provides a user with a variety of media playlists including the retrieved media items associated with the specified period of time.

In one embodiment, a user is provided with the option of specifying a time of the day. The playlist generation module 114 retrieves those media items that were selected for playback during the specified time of day and generates a media playlist that generally reflects the relative popularity of the retrieved media items with the user. This feature enables, for example, a user to listen to a sequence of songs that the user typically accesses for playback in the evening.

In one embodiment, the playlist generation module 114 includes a media database 202, an event database 204, an event generation module 206, a media collection module 208, a first media item generation module 210 and a playback sequence generation module 212. The media database 202 is used to store media items that are available to a user for playback. The event database 204 is used to store event state vectors. An event state vector is generated each time a user accesses a media item for playback. The event state vector includes a media item identifier that identifies the media item selected for playback and an access time parameter that specifies the time that the media item was selected for playback. In one embodiment, the event state vector includes a play duration parameter. The play duration parameter quantifies the duration of the playback of the selected media item.

The event generation module 206 generates the event state vectors. The media collection module 208 generally identifies the media items accessed for playback during a user specified period of time. The first media item generation module 210 generally determines the first media item in the ordered sequence of media items in the media playlist. The playback sequence generation module 212 generates the ordered sequence of media items that follow the first media item in the media playlist.

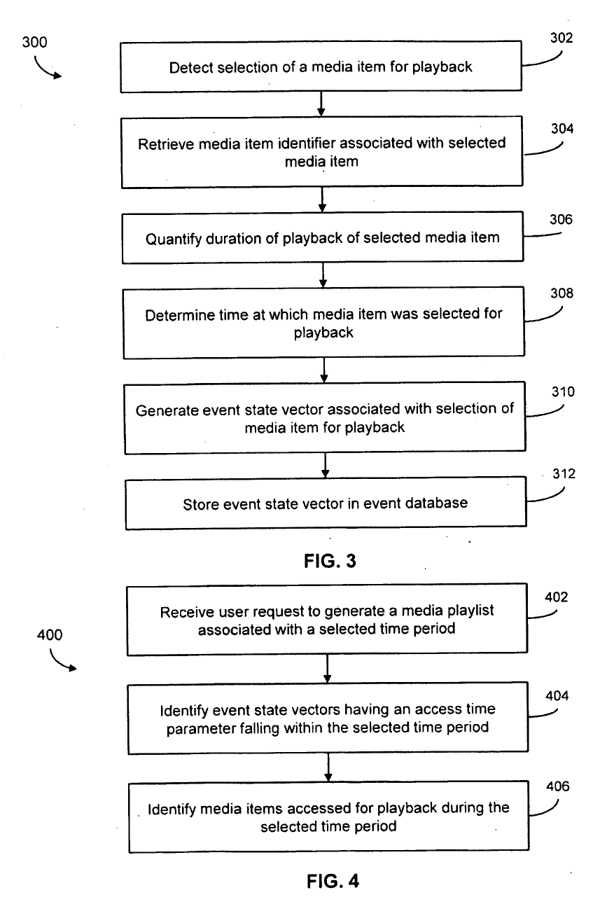

Referring to FIG. 3, a flowchart representation of one embodiment of a method 300 of generating an event state vector is shown. An event state vector is generated every time a user accesses a media item from the media database 202 for playback. The event state vector generation process is triggered when the event generation module 206 detects the selection of a media item for playback at step 302. The event generation module 206 retrieves the media identifier associated with the selected media item at step 304.

In one embodiment, the event generation module 206 quantifies the duration of the playback of the selected media item at step 306. The event generation module 206 generates a play duration parameter that defines the quantified duration of playback. In one embodiment, the duration of playback is quantified as a percentage. For example, if a selected media item happens to be a song with a total playback time of five minutes and a user decides to discontinue playback of the song after two minutes, the duration of playback is quantified as 40%. In one embodiment, the duration of playback is quantified as the actually period of playback. For example, if a user selects a photograph for viewing and views the photograph for two minutes, the duration of playback is quantified as two minutes. In one embodiment, the duration of playback is quantified based on the type of media item selected for playback.

The event generation module 206 determines the time at which the selected media item was accessed for playback at step 308. The event generation module 206 generates an access time parameter representative of the time that the media item was accessed for playback. In one embodiment, the access time parameter represents the absolute time at which the media item was accessed for playback. In one embodiment, the access time parameter represents the Coordinated Universal Time (UTC) at which the media item was selected for playback. The event generation module 206 generates an access time parameter representative of the time that the media item was accessed for playback.

The event generation module 206 generates an event state vector associated with the selected media item at step 310. In one embodiment, the event state vector includes the media identifier and the access time parameter. In one embodiment, the event state vector includes the media identifier, the access time parameter and the play duration parameter. The event generation module 206 stores the generated event state vector in the event database 204 at step 312. While the steps in the method 300 have been described in a particular order, the steps may be performed in a different order. Additional steps may be performed in addition to the described steps. A subset of the described steps may be performed. Furthermore, while one embodiment of a method generating an event state vector has been described, alternative embodiments may employ alternative methods of generating an event state vector.

Referring to FIG. 4, a flowchart representation of one embodiment of a method 400 of identifying media items accessed for playback during a user specified period of time is shown. The media collection module 208 generally generates a list of media items accessed for playback during a user specified period of time. The media collection module 208 receives a user request to generate a media playlist associated with a specified period of time at step 402. The media collection module 208 retrieves the event state vectors including an access time parameter that falls within the user specified period of time from the event database 204 at step 404. The media collection module 208 generates a list of the media items accessed for play during the specified period of time at step 406. More specifically, the media collection module 208 retrieves the media item identifiers from each of the retrieved event state vectors. The media collection module 208 compiles a list of the plurality of media items accessed during the specified period of time based on the retrieved media identifiers. While the steps in the method 400 have been described in a particular order, the steps may be performed in a different order. Additional steps may be performed in addition to the described steps. A subset of the described steps maybe performed. Furthermore, while one embodiment of a method of identifying media items accessed for playback during a user specified period of time has been described, alternative embodiments may employ alternative methods of identifying media items accessed for playback during a user specified period of time.

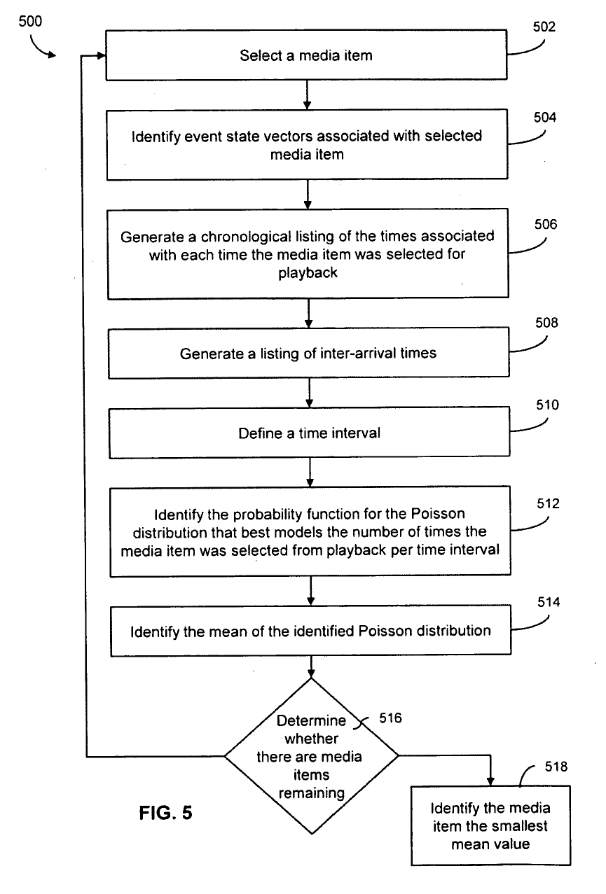

Referring to FIG. 5, a flowchart representation of one embodiment of a method 500 of selecting a first media item in an ordered sequence of media items in a media playlist is shown. The first media item generation module 210 selects a media item from the plurality of media items generated by the media collection module 208 at step 502. The first media item generation module 210 reviews the event state vectors that have been identified by the media collection module 208 as having an access time parameter that falls within the user specified period of time to identify those event state vectors associated with the selected media item at step 504. The first media item generation module 210 retrieves the access time parameters from each of the event state vectors associated with the selected media item and generates a chronological listing of the access time parameters at step 506.

The first media item generation module 210 generates a listing of inter-arrival times at step 508. An inter-arrival time is defined as the difference between two consecutive access time parameters in the chronological sequence. The first media item generation module 210 calculates an inter-arrival time for each of the consecutive pairs of access time parameters in the chronological listing of the access time parameters. For example, if the selected media item was selected for playback at 2 pm and then selected again at 4 pm on a particular day, the inter-arrival time associated with those two access time parameters is two hours.

At step 510, the first media item generation module 210 identifies the probably mass function of a Poisson distribution that approximately models the number of times the media item was selected for playback per interval of time. The x-axis of a Poisson distribution represents the number of occurrences of an event per interval of time. The y-axis or Pₓ(x) of a Poisson distribution represents the probability that a certain number of occurrences of an event x will occur per interval of time. The shape of a Poisson distribution depends on the mean value A of the distribution. In other words, a specific value of λ is associated with a specific shape of a Poisson distribution. A random variable x is said to follow a Poisson distribution if it has a probability mass function defined by Equation 1:

$${P}_{x} ( x ) = \frac{{e}^{- λ} {λ}^{x}}{x !} \qquad ( Equation 1 )$$

for x=1, 2, 3, . . . where x is the number of occurrences per interval of time, and λ is any number greater than zero and represents the mean of the Poisson distribution. Pₓ(x) defines the probability that an event will occur an x number of times per interval of time. For example, P₁(1) is the probability that an event will occur once per interval of time for a specific Poisson distribution defined by a specific value of a mean λ.

The event in this case is the playback of the selected media item. The number of occurrences per period of time is the number of times the selected media item was played back per interval of time. The values associated with the approximate number of times the selected media item was selected for playback per interval of time are used to identify a Poisson distribution that approximately fits these values. Once the specific Poisson distribution has been identified, the first media item generation module 210 determines the mean value associated with the identified Poisson distribution. The mean value represents the mean or the average interval of time.

This process is repeated for each of the plurality of media items accessed for playback by the user during the specified period of time. At step 514, the first media item generation module 210 determines whether any of the plurality of media items accessed for playback during the user specified period of time are still awaiting processing to determine an associated mean value. If there are media items remaining, the method 500 returns to step 502 and the next media item from the plurality of media items is selected and steps 504-512 are repeated for the selected media item. If there are no additional media items remaining, the method 500 proceeds to step 516. The first media item generation module 210 compares the mean values associated with each of the plurality of media items and identifies the media item with the lowest associated mean value at step 516. The media item with the lowest associated mean value (mean interarrival time for this media is the lowest, in other words it is played or viewed most frequently on average) is selected as the first media item for playback in the ordered sequence of media items in the media playlist. While the steps in the method 500 have been described in a particular order, the steps may be performed in a different order. Additional steps may be performed in addition to the described steps. A subset of the described steps maybe performed.

In one embodiment, the first media item generation module 210 determines the number of times each of the plurality of media items was accessed for playback during the user selected period of time. The first media item generation module 210 selects the media item with the highest number of accesses for playback during the user selected period of time at the first media item in the media playlist. Furthermore, while a number of different methods for selecting the first media item in a media playlist have been described, alternative embodiments may employ alternative methods of selecting the first media item in a media playlist.

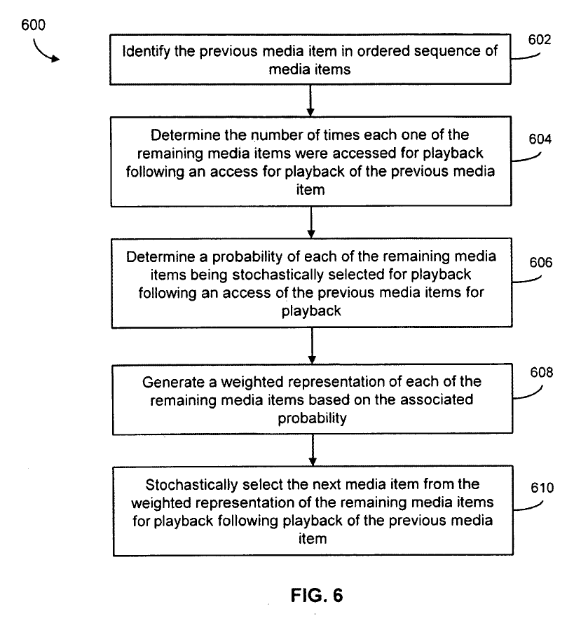

Referring to FIG. 6, a flowchart representation of one embodiment of a method 600 of generating a next media item in a media playlist is shown. The playback sequence generation module 212 begins the process of generating the media playlist using the first media item determined by the first media item generation module 210. The playback sequence generation module 212 uses the method 600 to determine the next or second media item in the media playlist. The playback sequence generation module 212 repeats method 600 to determine the third media item and continues to repeat method 600 until each of the plurality of media items have been ordered in a sequence for playback thereby generating the media playlist.

The method 600 begins at step 602 with the playback sequence generation module 212 identifying the previous media item in the ordered sequence of media items generated thus far in the media playlist. During the first iteration of method 600, the previous media item is the first media item determined by the first media item generation module 210. At step 604, the playback sequence generation module 212 determines the number of times each one of the remaining media items of the plurality of media items were accessed for playback following an access for playback of the previous media item during the user specified period of time. For example, if the plurality of media items consists of four media items and this is the first iteration of method 600, the playback sequence generation module 212 determines the number of times each one of the remaining three remaining media items were accessed for playback following an access for playback of the first media item during the user specified period of time. The playback sequence generation module 212 may, for example, determine that each of the second, third, and fourth media items were accessed for playback five times, thirteen times and seven times, respectively, following an access for playback of the first media item during the user specified period of time.

At step 606, the playback sequence generation module 212 determines the probability of each of the remaining media items of the plurality of media items being stochastically selected for playback based on the number of times such media items were actually accessed for playback following a playback of the previous media item. In the example where the playback sequence generation module 212 determined that the second, third, and fourth media items were played five times, thirteen times and seven times, respectively following a playback of the first media item during the user specified period of time, the playback sequence generation module 212 would determine that the probability that each of the second, third and fourth media items will be stochastically selected for playback following an access for playback of the first media item would be 0.20, 0.52 and 0.28, respectively.

The playback sequence generation module 212 generates a weighted representation of each of the remaining media items based on the associated probability of being stochastically selected for playback following the previous media item at step 608. In one embodiment, the playback sequence generation module 212 retrieves the play duration parameters associated with each of the media items. The playback sequence generation module 212 generates a weighted representation of each of the remaining media items based on the associated probability of being stochastically selected for playback following the previous media item and based on the associated play duration parameter. In one embodiment, the weighted representation of each of the remaining media items based on the associated probability of being stochastically selected for playback following the previous media item is generated in accordance with a Markov model.

At step 610, the playback sequence generation module 212 stochastically selects the next media item for playback following a playback of the previous media item from the weighted representation of the remaining media items. In the illustrative example, the probability of each of the second, third and fourth media items being stochastically selected for playback following a playback of the previous media item are 0.20, 0.52 and 0.28 respectively. Once the next media item has been stochastically selected for playback, the “next media item” is designated the “previous media item” and the playback sequence generation module 212 repeats method 600 to determine the next media item. The playback sequence generation module 212 repeats method 600 until all of the media items that were identified by the media collection module 208 as having been selected for playback during the user specified period of time have been ordered in a sequence thereby generating a media playlist.

The use of method 600 enables a playlist generation module 114 to generate different ordered sequences of media items in media playlists using the same plurality of media items where the ordered sequence generally represents user preferences or interests. In other words, the user may select the same specified period of time to generate a second media playlist, and the method 600 may generate a different ordered sequence of the same plurality of media items for playback in the second media playlist.

In one embodiment, method 600 is performed iteratively and the entire media playlist is generated prior to playback of any of the media items in the media playlist. In one embodiment, the method 600 is performed on a real time basis. In other words, the media playback device 100 begins playback of the previous media item and generates the next media item for playback as soon as playback of the previous media item is complete. While the steps in the method 600 have been described in a particular order, the steps may be performed in a different order. Additional steps may be performed in addition to the described steps. A subset of the described steps maybe performed.

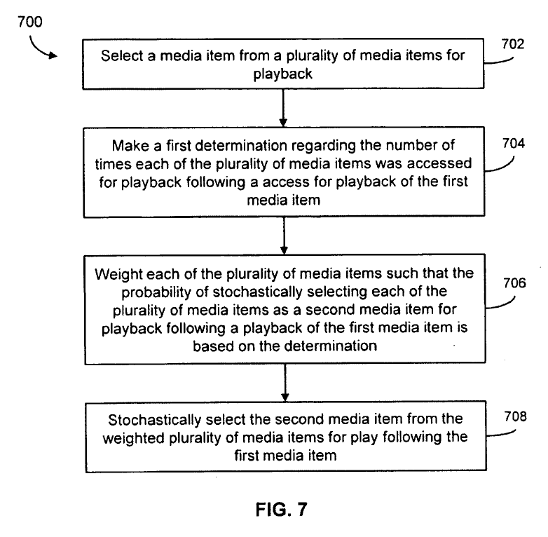

Referring to FIG. 7, a flowchart representation of one embodiment of a method 700 of generating a media playlist is shown. A first media item is selected from a plurality of media items for playback at step 702. A first determination is made regarding the number of times each of the plurality of media items was accessed for playback following an access for playback of the first media item at step 704. Each of the plurality of media items is weighted such that the probability of stochastically selecting each of the plurality of media items as a second media item for playback following a playback of the first media item is based on the first determination at step 706. The second media item is stochastically selected from the weighted plurality of media items for playback following the first media item at step 708. While the steps in the method 700 have been described in a particular order, the steps may be performed in a different order. Additional steps may be performed in addition to the described steps.

In one embodiment, a system 100 for generating a media playlist includes a playlist generation module 114. The playlist generation module 114 is operable to select a first media item from a plurality of media items for playback, make a first determination regarding the number of times each of the plurality of media items was accessed for playback following an access for playback of the first media item, weight each of the plurality of media items such that the probability of stochastically selecting each of the plurality of media items as a second media item for playback following a playback of the first media item is based on the first determination and stochastically select the second media item from the weighted plurality of media items for playback following the first media item.

In one embodiment, a computer readable medium stores a computer executable program for generating a media playlist. The computer readable medium includes computer readable code for selecting a first media item from a plurality of media items for playback, computer readable code for making a first determination regarding the number of times each of the plurality of media items was accessed for playback following an access for playback of the first media item, computer readable code for weighting each of the plurality of media items such that the probability of stochastically selecting each of the plurality of media items as a second media item for playback following a playback of the first media item is based on the first determination and computer readable code for stochastically selecting the second media item from the weighted plurality of media items for playback following the first media item.

In one embodiment, a computer readable medium stores a computer executable program for relatively ranking popularity of media items. The computer readable medium includes computer readable code for selecting a period of time, computer readable code for identifying a first probability mass function of a Poisson distribution that approximately models the number of times that a first media item was accessed for playback per time interval during the selected period of time, computer readable code for identifying a second probability mass function of a Poisson distribution that approximately models the number of times that a second media item was accessed for playback per time interval during the selected period of time, computer readable code for determining whether a first mean value of the first probability mass function is smaller than a second mean value of the second probability mass function and computer readable code for ranking one of the first and second media items as being relatively more popular than the other one of the first and second media items based on the determination.

It should be noted that while systems implemented using software or firmware executed by hardware have been described above, those having ordinary skill in the art will readily recognize that the disclosed systems could be implemented exclusively in hardware through the use of one or more custom circuits, such as for example, application-specific integrated circuits (ASICs) or any other suitable combination of hardware and/or software.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A system for generating a media playlist comprising:
a playlist generation module operable to:
select a first media item from a plurality of media items for playback,
make a first determination regarding the number of times each of the plurality of media items was accessed for playback following an access for playback of the first media item,
weight each of the plurality of media items such that the probability of stochastically selecting each of the plurality of media items as a second media item for playback following a playback of the first media item is based on the first determination, and
stochastically select the second media item from the weighted plurality of media items for playback following the first media item.

2. The system of claim 1, wherein the playlist generation module is operable to select a period of time and make the first determination regarding the number of times each of the plurality of media items was accessed for playback following an access for playback of the first media item during the selected period of time.

3. The system of claim 1, wherein the playlist generation module is operable to weight each of the plurality of media items in accordance with a Markov model.

4. The system of claim 1, wherein the playlist generation module is operable to:
select a period of time,
determine the number of times each of the plurality of media items was accessed for playback during the selected period of time, and
select the media item with the highest number of accesses for playback during the selected period of time as the first media item.

5. The system of claim 1, wherein the playlist generation module is operable to:
select a period of time,
identify a probability mass function of a Poisson distribution for each of the plurality of media items that approximately models the number of times that each of the plurality of media items was accessed for playback per time interval during the selected period of time,
determine a mean value for each of the plurality of media items based on the associated Poisson probability mass function, and
select the media item associated with the lowest mean value as the first media time.

6. The system of claim 1, wherein the playlist generation module is operable to:
detect when one of the plurality of media items has been accessed for playback, and
store media data associated with the detected media item, the media data being selected from a group consisting of an access time parameter, a play duration parameter and a media item identifier.

7. The system of claim 1, the playlist generation module is operable to:
generate an event state vector associated with each access of a media item from the plurality of media items for playback, the event state vector including a media item identifier and an access time parameter, and
store the event state vector in an event database.

8. The system of claim 1, wherein the playlist generation module is operable to:
select the first media item from the plurality of media items for playback, the plurality of media items being of a media item type selected from a group consisting of a music media item, an image media item and a video media item.

9. The system of claim 1, wherein the playlist generation module is operable to:
make a second determination regarding a duration of playback for each of the plurality of media items accessed for playback following an access for playback of the first media item, and
weight each of the plurality of media items such that the probability of stochastically selecting each of the plurality of media items as a second media item for playback following a playback of the first media item is based on the first and second determinations.

10. A computer readable medium for storing a computer executable program for generating a media playlist, the computer readable medium comprising:
computer readable code for selecting a first media item from a plurality of media items for playback;
computer readable code for making a first determination regarding the number of times each of the plurality of media items was accessed for playback following an access for playback of the first media item;
computer readable code for weighting each of the plurality of media items such that the probability of stochastically selecting each of the plurality of media items as a second media item for playback following a playback of the first media item is based on the first determination; and
computer readable code for stochastically selecting the second media item from the weighted plurality of media items for playback following the first media item.

11. The computer readable medium of claim 10, further comprising computer readable code for selecting a period of time and wherein the computer readable code for determining the number of times each one the plurality of media items was accessed for playback comprises computer readable code for determining the number of times each of the plurality of media items was accessed for playback during the selected period of time.

12. The computer readable medium of claim 10, wherein the computer readable code for weighting each of the plurality of media items comprising computer readable code for weighting each of the plurality of media items in accordance with a Markov Model.

13. The computer readable medium of claim 10, wherein the computer readable code for selecting a first media item comprises:
computer readable code for selecting a period of time;
computer readable code for determining the number of times each of the plurality of media items was accessed for playback during the selected period of time; and
computer readable code for selecting the media item with the highest number of accesses for playback during the selected period of time as the first media item.

14. The computer readable medium of claim 10, wherein the computer readable code for selecting a first media item comprises:
computer readable code for selecting a period of time;
computer readable code for identifying a probability mass function of a Poisson distribution for each of the plurality of media items that approximately models the number of times that each of the plurality of media items was accessed for playback per time interval during the selected period of time;
computer readable code for determining a mean value for each of the plurality of media items based on the associated Poisson probability mass function; and
computer readable code for selecting the media item associated with the lowest mean value at the first media time.

15. The computer readable medium of claim 10, further comprising:
computer readable code for detecting when one of the plurality of media items has been accessed for playback; and
computer readable code for storing media data associated with the selected media item, the media data being selected from a group consisting of an access time parameter, a play duration parameter and a media item identifier.

16. The computer readable medium of claim 10, further comprising:
computer readable code for generating an event state vector associated with each access of a media item from the plurality of media items for playback, the event state vector including a media item identifier and an access time parameter; and
computer readable code for storing the event state vector in an event database.

17. The computer readable medium of claim 10, wherein the computer readable code for selecting a first media item from a plurality of media items for playback comprising computer readable code for selecting a first media item from a plurality of media items for playback, the plurality of media items being of a media item type selected from a group consisting of a music media item, an image media item and a video media item.

18. The computer readable medium of claim 10, further comprising computer readable code for making a second determination regarding a duration of playback for each of the plurality of media items accessed for playback following an access for playback of the first media item; and
computer readable code for weighting each of the plurality of media items such that the probability of stochastically selecting each of the plurality of media items as a second media item for playback following a playback of the first media item is based on the first and second determinations.

19. A computer readable medium for storing a computer executable program for relatively ranking popularity of media items, the computer readable medium comprising:
computer readable code for selecting a period of time;
computer readable code for identifying a first probability mass function of a Poisson distribution that approximately models the number of times that a first media item was accessed for playback per time interval during the selected period of time;
computer readable code for identifying a second probability mass function of a Poisson distribution that approximately models the number of times that a second media item was accessed for playback per time interval during the selected period of time;
computer readable code for determining whether a first mean value of the first probability mass function is smaller than a second mean value of the second probability mass function; and
computer readable code for ranking one of the first and second media items as being relatively more popular than the other one of the first and second media items based on the determination.

20. The computer readable medium of claim 19, further comprising computer readable code for providing first and second media items, the first and second media items being of a media item type selected from a group consisting of a music media item, an image media item and a video media item.
